(19) United States
(12) Patent Application Publication
(10) Pub. No.: US 2012/0261531 A1
(43) Pub. Date: Oct. 18, 2012

(54) Vertical Flip-Top Menu Display

(76) Inventor: Marvin R. Doerfler, Savannah, GA (US)

(21) Appl. No.: 13/444,880

(22) Filed: Apr. 12, 2012

Related U.S. Application Data
(60) Provisional application No. 61/474,883, filed on Apr. 13, 2011.

(51) Int. Cl. G09F 1/10

(52) U.S. Cl. 248/158

(57) ABSTRACT

An independent, vertical card display stand, constructed such that display cards are exhibited and securely affixed to a vertical supporting member via a slanted slit or gap in a cylindrical mount. The present invention functions to preserve the integrity of the flipping menu or cards, as well as ensure their security against theft, deterioration due to wear, as well as other detriments, for a great period of time.

### CONTINUITY DATA

This is a non-provisional application of provisional application No. 61/474,883 filed on Apr. 13, 2011 and priority is claimed thereto.

### FIELD OF THE PRESENT INVENTION

The present invention, an independent, self-supporting menu display, is designed to hold multiple graphical or textual cards, as well as to display these cards on a table or countertop to the public. The present invention is configured in such a way that the menu cards or advertisements are mounted to the present invention securely, such that they may not be easily tampered with, removed, or lose any significant structural integrity over the life cycle of the menu. The present invention accomplishes this feat through the use of a unique slanted slit or gap, which is self-sealing due to the inherent tension provided by the acrylic or plastic-based cylindrical card holder, keeping the cards secure, and vertical stand providing stability for the present invention.

### BACKGROUND OF THE INVENTION

Advertising is a lot like real estate. In fact, it's often heard that the most important parts of each are ‘location, location, location.’ Though there are many different variants for advertisements in today's culture, it is often the specific locality of the advertisement that most determines its efficacy. For example, car dealers wish to advertise what cars they have on the lot to people who are proximal to the lot itself, and happen to be in the market for a car—as these individuals are the most likely to purchase. Similarly, food vendors and restaurant owners wish to advertise their delicacies to hungry customers, preferably those proximal to their store, or perhaps even already in their store or restaurant, enticing them with something perhaps more expensive than what the customer originally planned on eating. An effective, durable, and sturdy menu display system should be employed to actively target appropriate, proximal potential customers at the point-of-sale (restaurant table, bar, etc.) while maintaining a high level of quality, security, and integrity over great periods of time.

A common avenue for restaurant owners is to advertise their food specials or drink menus to their customers as they are greeted at the door, or as they are sitting down at their table or booth. A sub-optimal way to convey such information is via a paper menu or small table-based information packet. Oftentimes, these menus are designed to be held in the hand similar to a common paperback book. Unfortunately, due to their hand-held nature and paper construction, most menus must be replaced every month due to excessive wear from hundreds of customers' hands, as well as due to food stains that inevitably appear on any restaurant's menus. Similarly, if these menus are not replaced, their detriment and decay casts a dismal light on the establishment, often hindering business image. Flier or book-type paper menus also run a high risk of being stolen, thrown out, or destroyed by restless children while awaiting arrival of their meals.

Consequently, maintaining an effective menu system designed to be kept on a table or bar persistently throughout the entire course of a meal can be paramount to generating desire in the mind of the consumer for additional foodstuffs or drinks. Subjecting consumers to a mild bombardment of advertisements for specialty desserts or drinks can brew interest for a delicious dessert as they wait for their primary entrée to arrive, as it can be difficult for some to endure an enticing image of chocolate cake or ice cream for the entire duration of the consumer's meal without at least subconsciously craving the product. It is for this reason that it is advantageous to proprietors to place vivid images, often in the form of cards or menus, semi-permanently on their tables or bars.

Additionally, some traditional book-type menus at restaurants are bound together such that if the owner of the establishment wishes to edit or remove a page from the menu, the page must either be ripped out physically or the entire menu must be replaced. This places a higher cost on the maintenance of the menus, further decreasing the establishment's return on their investment (ROI). If restaurant owners were able to easily replace single pages of their menus without the hassle and expense of replacing the entire menu, financial resources could then be saved for other restaurant operations or expenses.

Similarly, traditional book menus have a tendency to fall off of tables and bars in restaurant environments that are mobile, turbulent, or unstable. This is often the case for restaurants on cruise liners or other private boats, private jets, or eateries on trains. This causes time to be expended picking up the menus, removing detriment, drying them, and ensuring they remain clean for future use after dropping to the floor or falling in spoiled food or drink. Time could be saved if proprietors implemented a more stable type of menu system.

Incidentally, other independently standing menu display systems have been conceived to attempt to combat these issues. However, some are crafted with multiple pieces that often must be disassembled in order to add or remove menu cards, which can be laborious. Additionally, customers or bored employees may deduce that the menu stand may be taken apart, which can increase their proclivity to dismantle the menu stand's pieces, causing them to get lost or broken.

Thus, there is a need for an independent, one-piece device that provides the proprietor of an establishment an avenue to maintain a quality menu system that is shatter resistant, tamper resistant, and stable on level surfaces, all while utilizing a menu card mounting mechanism geared to maximize the life of the menu and facilitate individual menu card replacements rather than replacing an entire paper menu.

### SUMMARY OF THE PRESENT INVENTION

The present invention is an upright, independent card display stand, designed to exhibit or advertise concepts such as venues, drinks, or food menu items, configured such that only one card may be viewed at once, yet has a capacity for multiple cards, which are stored in a flip-back manner, similar to a reporter's notebook. The present invention is also configured to withstand a great deal of wear, all while maintaining structural integrity. The preferred embodiment of the present invention would ideally involve four primary components: a base stand, a vertical supporting member, a secured cylindrical mount, and menu or advertisement display cards. A horizontal base stand supports the present invention, keeping it level on a table or countertop, ensuring a minimal chance for the present invention to topple or fall off of a table. Melded to the center of the base stand is a vertical member, composed of the same acrylic or plastic-based resin as the base stand, which extends slightly farther above the base stand than the envisioned length of the cards one wishes to store in the card holder. This is to ensure that the menu cards do not bind on the base stand as they are rotated around the present invention by the user, in order to display the subsequent card. Similarly, the length of the vertical supporting member is directly proportional to the width of the base stand, in order to preserve stability of the present invention. At the top of the vertical member is a small cylinder, analogous in size to both the width of the supporting member, as well as the mounting slits found on each menu card. The cylinder appears to be intact, however; in actuality, the cylinder is bifurcated at the base of the cylinder, thereabouts where the cylinder is affixed to the vertical supporting member, to provide an attachment avenue for the cards.

The gap or slit created by bifurcating the cylinder is at a low-grade angle, enhancing the illusion that the cylinder is whole, while also making it more difficult for customers targeted by the cards to remove or tamper with the cards, as the cards are less likely to escape the cylindrical mount during regular use. The inherent tension held within the curved, yet incomplete cylinder, also composed of plastic or acrylic resin, maintains the cylinder in a fully closed position when the card stand is in use, ensuring cards do not fall out accidentally, are tampered with, or easily removed. Additionally, the design also facilitates the removal of menu cards by the owner, as the tension of the cylinder is reduced via the force of gravity on the menu cards when the invention is inverted. When the present invention is stocked with cards for the first time, only slight tension provided by the owner's fingertips are required to open the cylinder wide enough to install menu cards.

The present invention functions to preserve the integrity of the flipping menu or cards, as well as ensure their security and durability for a great length of time.

### BRIEF DESCRIPTION OF THE DRAWINGS

FIG. 1 is an environmental view of the present invention.

FIG. 2 is a side view of the present invention.

FIG. 3 is a rear view of the present invention.

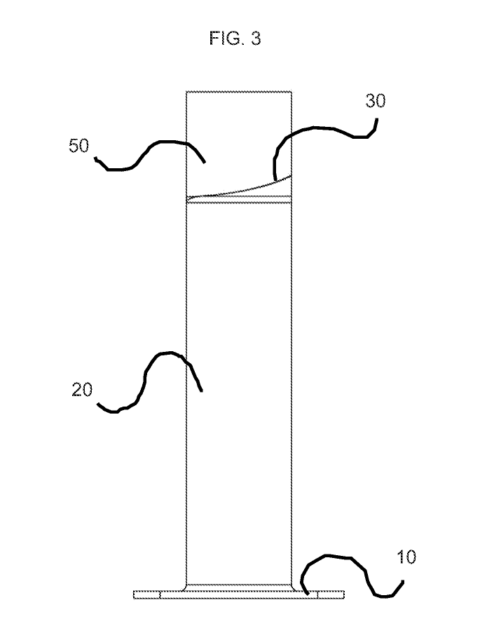

### DETAILED DESCRIPTION OF THE PRESENT INVENTION

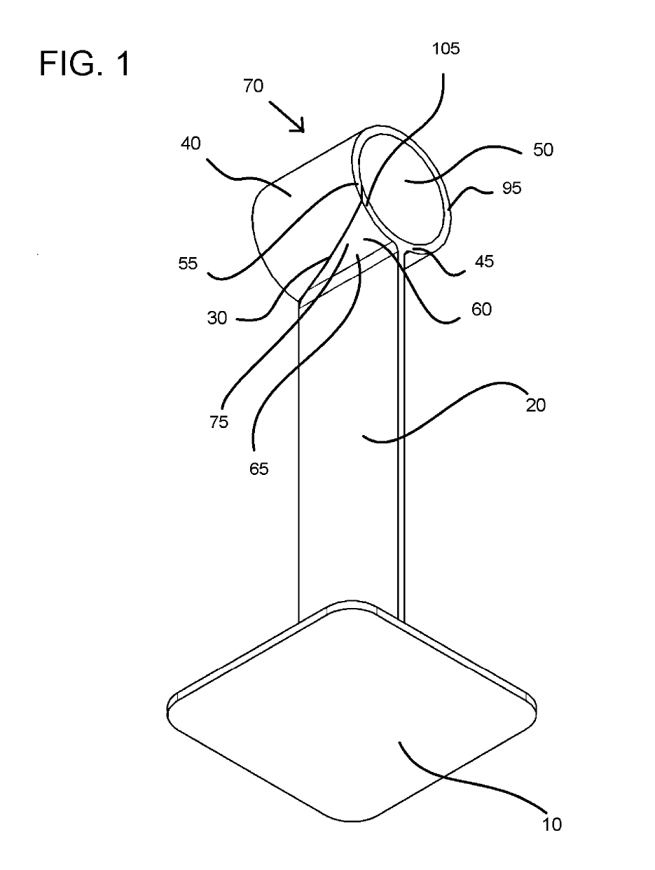

The present invention is a vertical menu card display stand, shown in its preferred embodiment in FIG. 1. It has a stable base stand (10), a vertical supporting member (20), and a cylindrical mount (70) on which to affix the desired menu or display cards. The length of the vertical support member (20) is directly proportional to the area of the base stand (10), providing added stability to the present invention. The base stand (10) is preferably made of a dense, plastic or acrylic resin which is shatter resistant. Therefore, the present invention can withstand falls from standard table or counter-top heights without breaking However, the base stand (10) may also be composed of wood, which is preferably permanently fastened to the vertical support member (10). The vertical support member (10) is preferably composed of a molded acrylic or plastic polymer. In embodiments of the present invention where the wood base replaces the acrylic base, the base is generally heavier than that of the acrylic base, which adds more stability to the present invention to resist the expanding force created when larger cards or plastic sleeves are rotated around the cylinder (70).

Display cards are affixed to the cylindrical mount (70) via the impermanent junction path of the two end points of the semi-circle of the incomplete cylindrical mount (70) amounting to a gap (30), which is angled such that it provides a smooth, notch-less interior of the cylindrical mount (70), making it less likely that menu cards could get caught on the gap (30) inadvertently and potentially escape the cylindrical mount (70). Maintaining a smooth interior to the cylindrical mount (70) additionally assists in the prevention of card loss via tampering or theft, as well as to minimize the risk of menu card deterioration from wear as the cards rotate around the cylindrical mount (70) as intended.

The nature of this gap (30), created via an angled bifurcation, is critical to the enhanced functionality of the present invention. When the present invention is at rest, tension created by the potential energy held within the acrylic or plastic of the cylindrical mount (70) maintains the entirety of the semi-circle in a closed position, yet not physically bonded such that a greater opposing force may be applied to open the cylindrical mount (70) slightly—ideally a distance great enough to install or remove menu cards. This opposing force to the internal tension of the cylinder (70) is potentially aided via the force of gravity when the present invention is inverted, especially if menu cards are present to provide added weight, increasing the apparent force of gravity on the cylindrical mount (70). Similarly, if the present invention falls over or falls off a table entirely, the pages of the menu will not fall out of the cylindrical mount due to the nature of the gap's (30) angular curvature, aided by the tension maintained by the flexible shape of the cylindrical mount (70), which maintains the semi-circle of the cylinder in a closed position, such that one cannot deduce that the cylindrical mount (70) is incomplete without close inspection.

It should be noted that the position of the gap (30) is critical to the functionality of the present invention. The gap (30) of the present invention is placed near one of the ends of the cylindrical mount (70), near the junction between the vertical support mount (20) and the cylindrical mount (70). The cylindrical mount (70) is preferably composed of acrylic, and is molded with the vertical support member and base stand, into one piece of solid acrylic or similar polymer. Positioning the gap at the end of the cylindrical mount (70) grants the most flexibility of the acrylic of the cylindrical mount (70) to bend to open and close easily. Positioning the gap in the middle of the cylinder, for instance, at the top of the cylinder, would reduce the flexibility of the cylindrical mount (70) to open, or to widen the gap (30) by half, thus requiring twice as much pressure to mount display cards to the cylindrical mount (70).

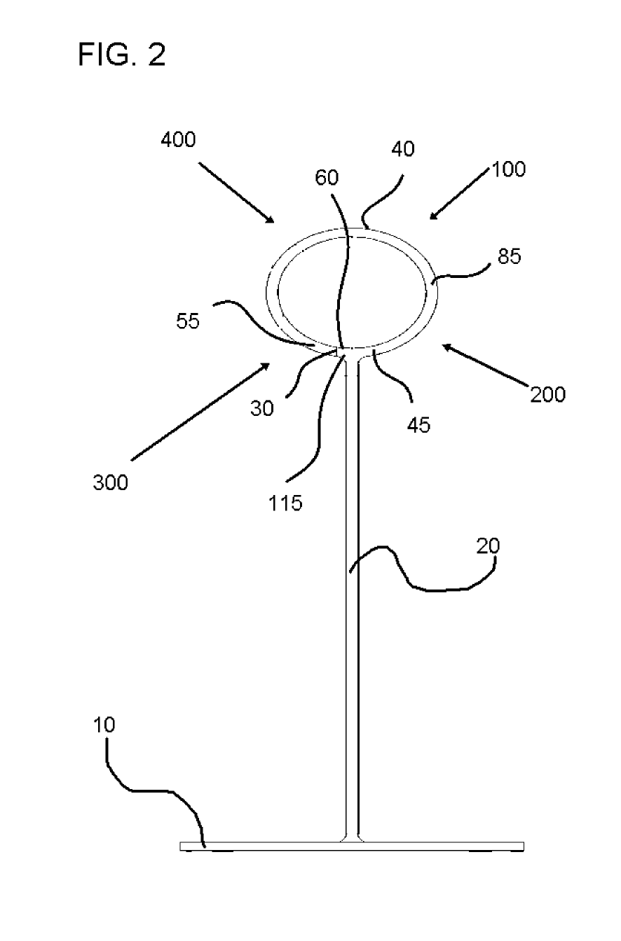

Another unique aspect to the incomplete semi-circle of the cylindrical mount (70) is the way in which the inferred gap (30) is crafted. FIG. 2 shows the left-hand side view of the preferred embodiment of the present invention, displaying the cylindrical mount (70) as a circle affixed to the vertical supporting member (20). This view demonstrates the nature of the gap (30) with respect to the inner portion of the circle. In FIG. 2, it should be understood that quadrant one (100), quadrant two (200), quadrant three (300), and quadrant four (400) are not physically demarcated on the present invention such that they would be observed by the user, but rather they are illustrated for the ease of description. With regards to a conventional 12-hour clock face, quadrant one (100) would extend from 12:00 to 3:00, quadrant two (200) would extend from 3:00 to 6:00, quadrant three (300) would extend from 6:00 to 9:00, and finally quadrant four (400) would then extend from 9:00 to 12:00. With this framework, it can be seen that the path of the junction point of the semi-circle which forms the gap (30) follows a curved path extending from the top of quadrant three (300)—at approximately 9:00—to the bottom of quadrant three (300), roughly at the juncture of the vertical support member (20) and the cylindrical mount (70) at approximately 6:00 in the preferred embodiment of the present invention.

From this perspective, one should note the angular nature (as non-perpendicular to the circumference of the cylindrical mount (70)) of the junction point of the semicircle which forms the perceived gap (30) as seen in FIG. 2. This angle is crucial to the interconnectivity of the two ends of the semi-circle. Having the cut at an angle masks the fact regarding the cylindrical mount's (70) incompleteness to the average consumer or user. Providing the illusion that the cylindrical mount (70) is complete and intact will help curb the desire of others to tamper with the menu cards, as they would not initially know the cards were removable without careful inspection.

In other words, the cylindrical mount (70) is composed of a first piece (40) and a second piece (60). Said first piece (40) is longer than said second piece (60). Said first piece (40) has a first piece first end (45) and a first piece second end (55). Said second piece (60) has a second piece first end (65) and a second piece second end (75). Said first piece first end (45) is in communication with said vertical support member (20). Said second piece first end (65) is in communication with said vertical support member (20). Said first piece second end (55) and second piece second end (75) are configured such that they are proximal to one another. Said first piece (40) has a first piece first edge (85) and a first piece second edge (95). The first piece first edge (85) extends longer than the first piece second edge (95). Said second piece (60) also has a second piece first edge (105) and a second piece second edge (115). Said second piece first edge (105) extends longer than said second piece second edge (115), as seen in FIG. 1 and FIG. 2.

In effect, this amounts to a semi-enclosed semi-circle, amounting to a cylinder, effectively functioning as said cylindrical mount (70) of the present invention.

Consequently, the cylindrical mount (70) on the present invention is configured to be opened for menu card installation and removal with relative ease by the trained proprietor, but not by an average customer. It is envisioned that in the preferred embodiment of the present invention, the proprietor wishing to install or remove menu cards would be able to accomplish this task independently, without the assistance of others, using only his or her two hands. Ideally, the proprietor would place his/her palm of his/her hand on the vertical support member (20) with a slight downward force while the present invention is lying on its side with the menu cards lying roughly parallel to the countertop, table, workbench, bar, or similarly level surface. This slight downward force provided by the proprietor's palm on the vertical support member (20) causes the vertical support member (20) to bend slightly, as it is made of a flexible plastic or acrylic resin. The flexing of the support member inwards, towards the level surface such as a table, causes the relatively flexible cylindrical mount (70) to separate the two ends of the semi-circle slightly, facilitating card installation or removal. This feature is possible due to the angled nature of the path of the junction point of the semi-circle as seen in FIG. 2, which amounts to a gap (30). The proprietor may then use his or her index finger and thumb of the same hand to open the cylindrical mount (70) an additional amount (if needed) to better facilitate card installation or removal. This method of card management keeps the proprietor's opposite hand free to handle the cards, placing them into the cylindrical mount (70), individually or in small groups, with his or her other hand.

The preferred embodiment of the present invention employs a slight parabolic curvature in creating the gap (30) in quadrant three (300) of the cylindrical mount (70) that facilitates menu card management. This bifurcation or cut, again, creates the path of the junction point of the semi-circle, which amounts to a gap (30) which provides the avenue for card installation and removal. In the preferred embodiment, this cut of the cylindrical mount (70) need not be at a specified angle, but rather simply ensured that the cut creating the gap (30) is not perpendicular to the X-axis of the cylinder, such that the path of the cut is curved. It should be noted that the bifurcation which creates the path of the gap (30) in the preferred embodiment of the present invention is parallel to the vertical support member (20) in the side view provided in FIG. 2, and not perpendicular to the edge of the cylindrical mount (70). This creates an angle to the gap's (30) incision which is instrumental to the security and ease of maintenance of the menu cards within the present invention. This angle of the gap's (30) incision, ensuring a smooth interior surface (50) of the cylindrical mount (70) in the present invention aides in securing the menu cards within the cylindrical mount (70) by providing additional insurance against the event of the cylindrical mount (70) opening unintentionally.

Additionally, the preferred embodiment of the present invention's bifurcation, found in quadrant three (300), located at the junction point between the two opposing ends of the semi-circle, which amounts to a gap (30), is maintained at the base of the vertical support member (20) in order to facilitate menu card removal. In the present embodiment of the invention, the gap (30) is configured to be located at the junction point between the base of the rear of the cylindrical mount (70) and the top of the vertical support member (20) as seen in FIG. 1, providing the semi-circle with a maximum degree of flexibility, facilitating one-handed opening of the cylindrical mount (70), such that a weaker opposing force is required to open the cylindrical mount (70) than if the gap (30) were to be located in another position on the cylindrical mount (70). This is not to say that alternate embodiments of the present invention could not maintain the gap (30) in a differing location on the cylindrical mount (70), but rather that the preferred embodiment configures the gap (30) to be located at the base of the cylindrical mount (70), near the junction of the cylindrical mount (70) and the vertical support member (20), curving diagonally towards the equator of the semi-circle, as viewed from the side in FIG. 1.

The preferred embodiment of the present invention is envisioned to be employed in an upright or standing-up fashion, unlike a paper flier or book-like menu; thus, the present invention is less likely to get food or drinks spilled on it in a restaurant environment than a conventional menu as the menu cards the present invention supports are rarely in contact with the table or ground. However, in other embodiments of the present invention, it can be envisioned that the present invention could be configured to function similarly well if placed on its side, horizontally, with the menu pages parallel to the table or bar, through the use of a modified base stand (10), especially in locales requiring additional stability, such as a menu system on a cruise liner. This is given that the stability of the present invention would be inherently increased if laid on its side, as it would maintain a lower center of gravity, providing a lesser likelihood that the present invention would topple if subjected to disruption. For example, it can be envisioned that an alternate embodiment of the present invention may employ a stouter base stand (10) that would be designed to be at rest on the present invention's side, such that the cylindrical mount (70) is resting on the counter or table, rather than held vertically. In this likeness, the present invention can be envisioned without the accompaniment of a base stand (10) at all. It can also be envisioned that stability may be added to the present invention by utilizing an embodiment with an elongated base stand (10), equal or greater in width than the height of the vertical supporting member (20).

It should also be understood that other embodiments of the present invention may employ a varying bifurcation line that is cut in a different position on the cylindrical mount (70), such as a bifurcating cut which creates the path of the junction point of the semi-circle which amounts to a gap (30), that extends from the top left of quadrant one (100) as seen in FIG. 2, to the bottom right of quadrant one (100), or any quadrant therein. Similarly, it can be envisioned that the cylindrical mount (70) need not be cylinder-shaped at all, but that the functionality of the present invention and the inherent mounting slit or gap (30) would not necessarily be hindered by implementing a hexagonal, octagonal, or other similarly enclosed shape.

Likewise, it should be understood that other embodiments of the present invention may include a variation on the format of the base stand (10), as well as a variant on the vertical supporting member (20). This could include, but is not limited to, crafting the base stand (10) into a differing geometrical shape, such as a rhombus, trapezoid, hexagon, triangle, or octagon, provided that the shape is still wide enough—yet proportional to the height of the present invention—to provide adequate stability and support for the present invention. Preserving functionality, the base stand (10) could be envisioned in a wide number of ways, such as having two supporting members instead of one vertical support member (20). For example, these two supporting members could be spread by a 35 degree angle or greater, given that they are at least as wide as the menu cards to be installed, which could then support the present invention in the form of a stable isosceles or equilateral triangle, with the counter or table serving as the bottom base of the triangle, supporting the present invention without need for a level or flat base stand (10). It should be implied that this alternate embodiment of the present invention would require wider vertical support member(s) (20) than the preferred embodiment of the present invention exhibits, in order to maintain the same high grade of stability.

Another alternate embodiment of the present invention may employ a variant of the formula for the acrylic or plastic based polymer which makes up the base stand (10), vertical support member (20), and the cylindrical mount (70). In the preferred embodiment of the present invention, the polymer is envisioned to be more rigid than flexible, ensuring the tension held within the cylindrical mount (70) does not substantially decrease as the cylindrical mount (70) is flexed open to remove or install additional cards numerous times. However, in alternate embodiments, the polymer's formula may be adjusted to accommodating varying environmental conditions. For example, an alternate embodiment of the present invention could employ a weaker or more rubber-based polymer which would be more resistant to sunlight and heat than conventional plastics which often become frail once subjected to long durations of sunlight or heat. In this manner, this alternate embodiment of the present invention would be better suited for an outdoor restaurant environment in which the proprietor may add or remove cards at will without fear of the flexible acrylic or plastic (namely the flexing cylindrical mount (70)) sacrificing durability by being displayed in direct sunlight.

Additionally, it is also envisioned that, in alternate embodiments of the present invention, the base stand (10) may be crafted out of wood. In this embodiment, the vertical support member (20) would preferably be mounted to the base stand (10) crafted out of wood via a mounting point in the base stand (10), preferably amounting to a slit or gap that the vertical support member (20) may fit snugly within. Alternately, the vertical support member (20) could be fused to the wood of the base stand (10), such that it is permanently mounted to the wood of the base stand (10).

Similarly, it should be understood that in alternative embodiments of the present invention, any components of the present invention, including the vertical support member (20), base stand (10), and the cylindrical mount (70) may maintain additional patterns, colors, and even small plastic cosmetic pieces designed for cosmetic purposes only. For example, the vertical support member (20) may have small plastic flowers affixed to the stand for display purposes. Similarly, the vertical support member (20) of the present invention may be fitted with vertical acrylic ridges created during the molding process, in order to add structural integrity to the vertical support member (20), making it more durable and less prone to damage.

It is understood that the present invention is not solely limited to the invention as described in the embodiments above, but further comprises any and all embodiments within the scope of the this application.

I claim:

1) A flip-top card display stand comprising:
a vertical support member;
a base stand;
a mount, said mount having a first piece and a second piece;
wherein said first piece has a first piece first end in communication with said vertical support member;
wherein said second piece has a second piece first end in communication with said vertical support member;
wherein said first piece has a first piece second end having a first piece first edge that is longer than a first piece second edge; and
wherein said second piece has a second piece second end having a second piece first edge that is longer than a second piece second edge.

2) The flip-top card display stand of claim 1, wherein said first piece second end and said second piece second end are disposed toward each other.

3) The vertical flip-top card display stand of claim 1, wherein said first piece and said second piece curve away from said vertical support member.

4) The vertical flip-top card display stand of claim 1, wherein said first piece and said second piece curve toward one another.

5) The vertical flip-top card display stand of claim 1, wherein said first piece curves vertically toward said second piece.

6) The vertical flip-top card display stand of claim 1, wherein said first piece and said second piece curve toward one another vertically.

7) The vertical flip-top card display stand of claim 1, wherein said first piece second edge is disposed at the vertical support member.

8) The vertical flip-top card display stand of claim 1, wherein said first piece second end and said second piece second end are disposed such that said first piece second end and said second piece second end never touch.

9) The flip-top card display stand of claim 1, wherein said first piece second end and said second piece second end are disposed to separate when a force is applied.

10) The vertical flip-top card display stand of claim 1, wherein said display cards are removable.

11) The vertical flip-top card display stand of claim 2, wherein said first piece and said second piece curve away from said vertical support member.

12) The vertical flip-top card display stand of claim 2, wherein said first piece and said second piece curve toward one another.

13) The vertical flip-top card display stand of claim 2, wherein said first piece curves vertically toward said second piece.

14) The vertical flip-top card display stand of claim 2, wherein said first piece and said second piece curve toward one another vertically.

15) The vertical flip-top card display stand of claim 2, wherein said first piece second edge is disposed at the vertical support member.

16) The vertical flip-top card display stand of claim 2, wherein said first piece second end and said second piece second end are disposed such that said first piece second end and said second piece second end never touch.

17) The vertical flip-top card display stand of claim 2, wherein said first piece second end and said second piece second end are disposed to separate when a force is applied.

18) A flip-top card display stand comprising:
a vertical support member;
a base stand;
a mount, said mount having a first piece and a second piece;
wherein said first piece has a first piece first end in communication with said vertical support member;
wherein said second piece has a second piece first end in communication with said vertical support member;
wherein said first piece has a first piece second end having a first piece first edge that is longer than a first piece second edge;
wherein said second piece has a second piece second end having a second piece first edge that is longer than a second piece second edge;
wherein said first piece second end and said second piece second end are disposed toward each other;
wherein said first piece second edge is disposed at the vertical support member;
wherein said first piece second end and said second piece second end are disposed such that said first piece second end and said second piece second end never touch;
wherein said first piece second end and said second piece second end are disposed to separate when a force is applied; and
wherein said display cards are removable.
